(19) United States
(12) Patent Application Publication
(10) Pub. No.: US 2001/0016803 A1
(43) Pub. Date: Aug. 23, 2001

(54) Design system and method for designing or constructing new parts

(76) Inventors: Ridwan Sartiono, Meine (DE); Peter Kellner, Wolfsburg (DE); Andreas T. Janocha, Heiligenmoschel (DE)

Correspondence Address: KENYON & KENYON, ONE BROADWAY, NEW YORK, NY, 10004, US

(21) Appl. No.: 09/732,958

(22) Filed: Dec. 8, 2000

(30) Foreign Application Priority Data
Dec. 10, 1999 (DE) 199 59 617.4

(51) Int. Cl. G06F 17/50; G06F 19/00

(52) U.S. Cl. 703/1; 700/97; 700/104; 700/105; 700/182

(57) ABSTRACT

A method and a design system for designing or constructing new parts of a design unit, in the context of a design-space environment made of already existing parts of the design unit, includes at least one CAx system and at least one central data base, which are interconnected by a data circuit. To permit new parts to be designed or constructed in a simplified, cost-effective, and timesaving manner, a design space for the design of the part is defined in the CAx system by a user and copied to the central data base. In the central data base, all of the already existing parts of the same design unit are ascertained, which, or whose design spaces, come in contact with the defined design space. The ascertained parts are copied completely, or in detail form, as a design-space environment, to the CAx system and represented in the correct position relative to the defined design space for designing the part.

### FIELD OF THE INVENTION

The present invention relates to a design system for designing or constructing new parts of a design unit, having at least one CAx system and at least one central data base, which are interconnected by a data circuit for exchanging data. The present invention also relates to a method for designing or constructing new parts of a design unit.

### BACKGROUND INFORMATION

Numerous CAx systems such as CAD, CAE, or CAM systems, which are used as CAD/CAE/CAM models for designing parts presently exist. Similarly, it is conventional to use design systems, which include a plurality of CAx systems and a central data base connected to the CAx systems, since, in order to plan a design unit, several CAx systems are often used within a company, for various design areas that must be coordinated with each other.

In the field of vehicle construction, using a vehicle as a design unit, a first CAD system Y can thus, for instance, be used in the body design, and a second CAD system X can be used in the engine and chassis design. If an engine part is then designed in CAD system X, then the part is subsequently converted, using standard format STEP (Standard for the Exchange of Product Model Data: international standard for a product data model, in accordance with ISO 10303) into the format of CAD system Y, and saved in a vehicle data base for collision testing. If discrepancies occur during collision testing, then the engine parts must be appropriately modified in CAD system X. This procedure may have to be repeated several times, until the vehicle data base reveals that the newly-designed part can be properly inserted between the parts already present. Therefore, the existing systems and methods are time-consuming and costly.

It is therefore an object of the present invention to provide a design system and method, which enable new parts of a design unit to be designed or constructed in a timesaving and cost-effective manner.

### SUMMARY

The above and other beneficial objects of the present invention are achieved by providing a design system for designing or constructing new parts of a construction unit, in the context of a design-space environment including already existing parts of the design unit, using at least one CAx system and at least one central data base which are interconnected by a data circuit for exchanging data. The CAx system includes an input device for defining a design space for the part to be designed, and for designing the part in this design space; a display device for displaying the design space, the design-space environment, and parts; as well as a copying device for copying the defined design space to the central data base. The central data base has access to the already existing parts of at least one design unit; and has a selection device for selecting the already existing parts of the design unit, which, or whose design spaces, overlap or border on the design space of the part to be designed new; as well as a copying device for copying the selected parts (completely or in detail form), together with information defining their position relative to the defined design space, as a design-space environment, to the CAx system.

The above and other beneficial objects of the present invention may also be achieved by providing a method for designing or constructing new parts of a design unit, in the context of a design-space enviroment including already existing parts of the design unit, using a design system having at least one CAx system and at least one central data base, which are interconnected by a data circuit. The method includes the following steps:

a) a design space, which is in the CAx system, is defined by a user, and is for a part to be designed in the CAx system, is copied to the central data base;

b) the central data base ascertains already existing parts of the design unit, or design spaces thereof, which border on or overlap the defined design space of the part to be designed;

c) the ascertained parts (complete or in detail form) and the information defining their position relative to the defined design space are copied to the CAx system; and

d) the detected parts are displayed in the correct position relative to the defined design space, as a design-space environment, for the design of the part to be designed in the defined design space.

The design system and the method according to the present invention allow an interactive determination of all of the finished parts that are located inside a defined design space of a part to be designed. The relevant parts are ascertained in a central data base. The ascertained parts are copied completely, or in detail form, from the central data base to the CAx system, which is used by the user to design the new part. The copied parts can then be combined in the CAx system, as a design-space environment, and provided to the user.

Using the design system and the method of the present invention, the user can neatly and precisely design a part in his or her CAx system, from the start, since he or she has the exact spatial delimitation from the already existing parts, in front of him or her. This avoids any necessity of subsequently changing this part in the central data base. Therefore, a considerable portion of the time and expense of the utilized method can be avoided.

All data for the already existing parts can be stored in the central data base itself, so that the data can be directly accessed. The geometric data for the already existing parts, which are generated by a CAx system and stored in the central data base, are written in the data format inherent to the specific CAx system, so that various data formats are used in response to employing different CAx systems. In addition, the design on a CAx system becomes independent of the current readiness of the other CAx systems for use. But in the same way, the central data base can also just store management or organizational data for the finished parts.

The method of the present invention may be used in an especially favorable manner, when not the ascertained, existing parts themselves, but rather the design-space-environment boxes defining the design spaces of the existing parts, and bordering on or overlapping the design space of the part to be designed new, are initially copied from the central data base to the CAx system. The design-space-environment boxes are then represented in the CAx system, together with the design space for the part to be designed, as a simplified design-space environment. On the basis of this view, the user can then select the design-space-environment boxes necessary for him, and can also trim these in such a manner, that only the immediate environment of the design space remains, or even just the periphery of the design space, itself. Then, the central data base only compiles the details from the existing parts, which correspond to these remaining design-space-environment boxes copied back to it, and it copies the details to the CAx system used for the design. This reduces the computational time for copying the detected parts, since only the geometric elements inside the corresponding details from the existing parts are converted into and copied to the CAx system used for the design. In addition, a large segment of the display area is available to the user for designing the part, since only the immediate environment of the part is displayed, and at the same time, he still sees all of the relevant, already existing elements of the design unit.

In one embodiment of the method according to the present invention, the user can optionally hide and unhide the design-space environment, while designing the new part in the CAx system. This further facilitates the design work.

A part that is being designed, but is not yet finished, may be stored in the CAx system, when the user would like to interrupt his design work. The design-space environment of the part may be separately managed and stored for continuing the design work later. If the user wants to continue his design work later, and loads his part into his CAx system, then the saved design-space environment may be automatically loaded without having to request a new design-space environment.

Furthermore, the design-space environment may be updated with new data from the central data base. This ensures that the design can always be carried out in the currently valid design-space environment, since other parts may be added in the course of the design. This equally takes into account, that existing parts may be omitted or could have been modified.

In another embodiment of the method according to the present invention, the representation in the CAx systems takes place in a design-space coordinate system, and the processing in the central data base is done in a design-unit coordinate system defined for each design unit, e.g., a vehicle. In this manner, a coordinate system matched with the geometry of the part to be designed can be used for the design in the CAx systems, while simultaneously allowing an overall view of the individual parts in a uniform coordinate system in the central data base. The transformation from the design-space coordinate system into the design-unit coordinate system may be performed using matrices, which may be determined for the installation position in the design unit or stored along with existing parts. A part may be a component part or an assembly, which may include a plurality of parts. Each part has a transformation matrix for defining its installation position in the assembly.

If the design'system is provided for designing parts of several different design units, e.g., for the parts of various vehicles, then these parts may include the appropriate transformation matrix for each vehicle in order to define the installation position of these parts in each design unit of this vehicle.

One field of application, in which the design system and method of the present invention are particularly useful, is the field of vehicle design. However, the system and method of the present invention may also be used in the design of other complex design units.

In the context of the present invention, a CAx system should be understood to include any computer-aided system for designing, developing, constructing, or modeling parts, in which a part may be any element of a unit made of a plurality of elements.

### BRIEF DESCRIPTION OF THE DRAWINGS

FIG. 1 is a schematic view of a design system according to the present invention;

FIG. 2 illustrates an example of a part to be designed, along with adjacent, already existing parts;

FIG. 3 illustrates a design space and design-space environment for the part to be designed as shown in FIG. 2;

FIG. 4 illustrates details of the parts belonging to the design-space environment, in accordance with an adjusted design-space environment shown in FIG. 3;

FIG. 5 is a schematic view of a data-storage structure of a CAD system belonging to a design system of the present invention;

FIG. 6 illustrates a management or organizational table within the framework of the data-storage structure illustrated in FIG. 5;

FIGS. 7a-7b illustrate a flow chart of the method according to the present invention; and

FIG. 8 illustrates an assignment of a part to an assembly and a vehicle using transformation matrices.

### DETAILED DESCRIPTION

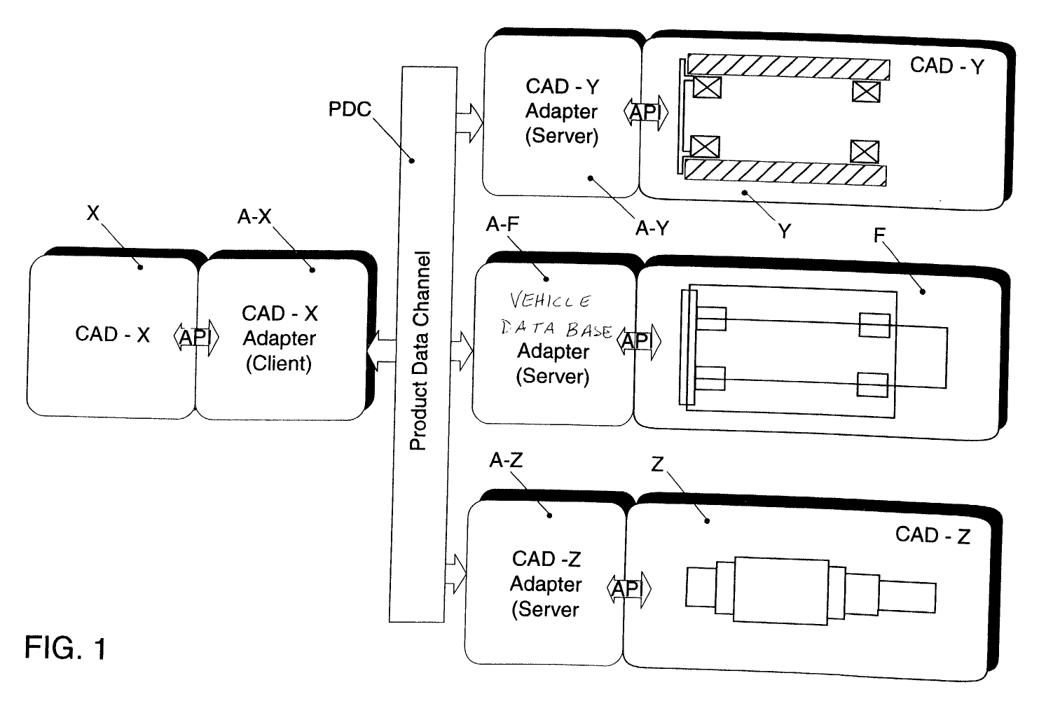

FIG. 1 is a schematic view of a design system according to the present invention, which may be used, for example, to design parts of various vehicles. A vehicle data base F serving as a central data base, a first CAD system X, a second CAD system Y, and a third CAD system Z, are each connected by an application programming interface API and an adapter A-X, A-Y, A-Z, A-F, to a product data channel PDC. Additional CAD systems and vehicle data bases, not shown, may be connected to the data channel.

Each of the three CAD systems X, Y, Z is used by designers to design parts of a specific vehicle area, such as, for example, the body, engine and chassis. The parts, which are defined in a design-space coordinate system and are generated by one of the CAD systems X, Y, Z, are stored along with their design-space box and a transformation matrix, in the design-space coordinate system in vehicle data base F. The transformation matrix defines the respective position of the parts in the vehicle coordinate system for the corresponding vehicle.

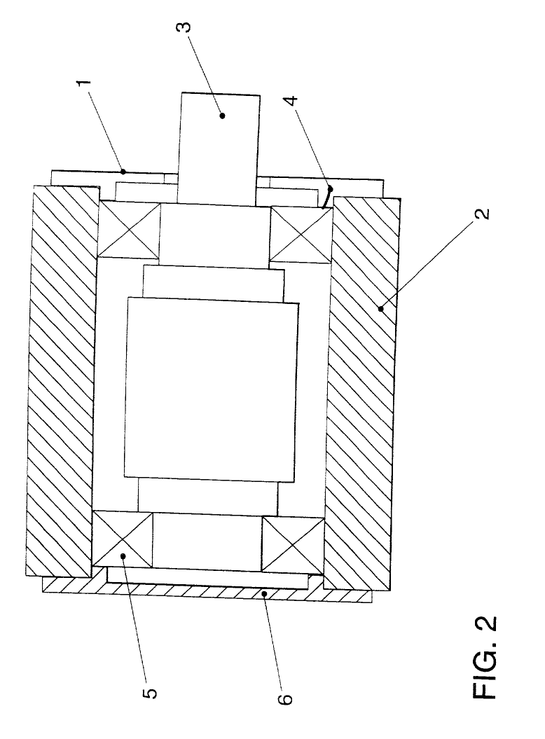

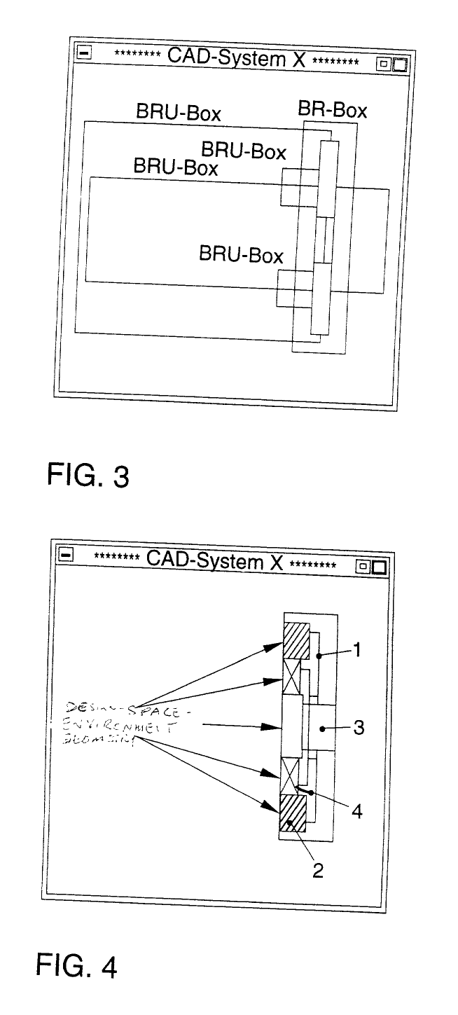

For example, if a designer wants to design, in CAD system X, a new cover 1 for a cylinder 2 having a shaft supported in it, as illustrated in FIG. 2, he may initially select, using the input device of utilized CAD system X, required vehicle data base F and the vehicle for which the part is intended, in case more than one vehicle data base exists, or in case data are available for several vehicles. In addition, he may define design space BR-Box, which is illustrated in FIG. 3, and inside which cover 1 may be designed. Upon copying design-space BR-Box from vehicle data base F, he may request the relevant design-space environment having the already existing parts for the selected vehicle. As a result, vehicle data base F ascertains the design-space-environment boxes for already existing parts 2, 3, 4, 5, 6 of the vehicle. In this context, each design-space-environment box BRU-Box may represent the design space of one of the already existing parts. All design-space-environment boxes BRU-Box, which border on or overlap design space BR-Box of the part to be designed, may be copied to CAD system X. In this case, these are design-space-environment boxes BRU-Box for parts 2, 3, 4. Consequently, a simplified design-space environment, which is made of design-space-environment boxes BRU-Box, and may also be seen in FIG. 3, is initially available in CAD system X.

If necessary, the designer may adjust the design-space environment, i.e., limit it to an area that he needs to be able to work effectively. This reduces the computational time for the subsequent copying of the ascertained parts, since only the geometric elements inside the limited area are converted and copied from CAD system Y and/or Z into CAD system X. In addition, more space is available to the designer for the new part to be designed than in the case of retaining the entire design-space environment. For the adjusted, simplified design-space environment, the exact design-space environment, which is made up of the already existing parts cut to the size of the adjusted design-space environment, is then requested from the vehicle data base.

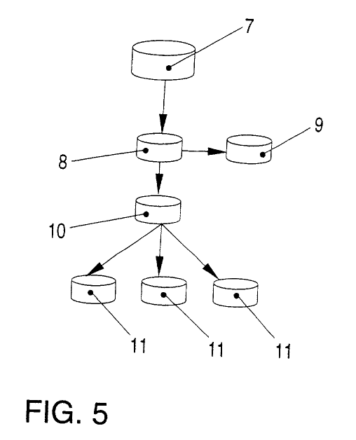

New part 1 can then be designed in this exact design-space environment shown in FIG. 4. In this case, it is clear that only the detail of cylinder 2, bearing 4, and shaft 3, which is important for designing the cover, is displayed for the designer.

Thereafter, newly designed part 1 may be saved with or without a design-space environment, which is primarily of interest when the design is not yet finished. When the newly designed part is worked on at a later time, either the already saved design-space environment may be loaded again automatically or a new design-space environment may be generated.

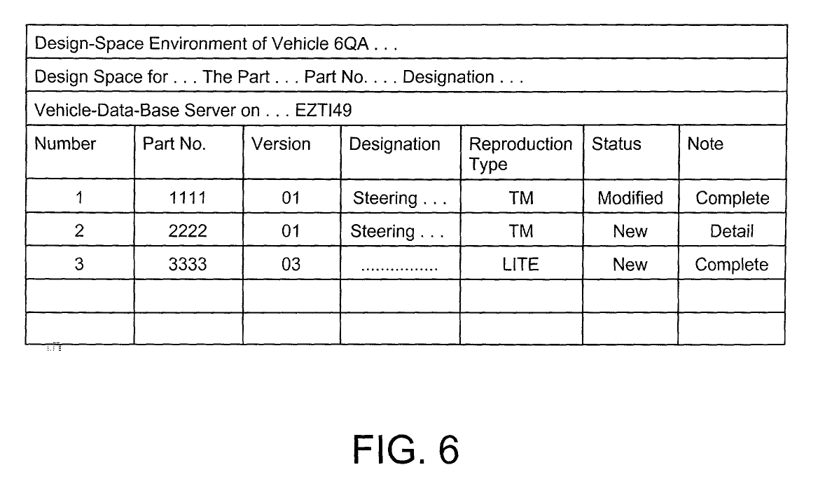

To store the data for the design-space environment, each of the CAD systems X, Y, Z may include the data-storage structure illustrated in FIG. 5.

The data for a part to be designed are stored in a part file 7 together with a flag that indicates whether a design-space environment was defined and stored for the part. The name of the storage file for this design-space environment may also be stored.

The name of vehicle data base F and the name of the vehicle for which the part is intended are stored in design-space-environment file 8 defined in this manner. Also stored may be the name of file 9 of an organizational table containing data about the design-space, in which the part is intended to be designed. Furthermore, a list of design-space-environment boxes may be stored. The name of design-space-assembly file 10 may also be stored.

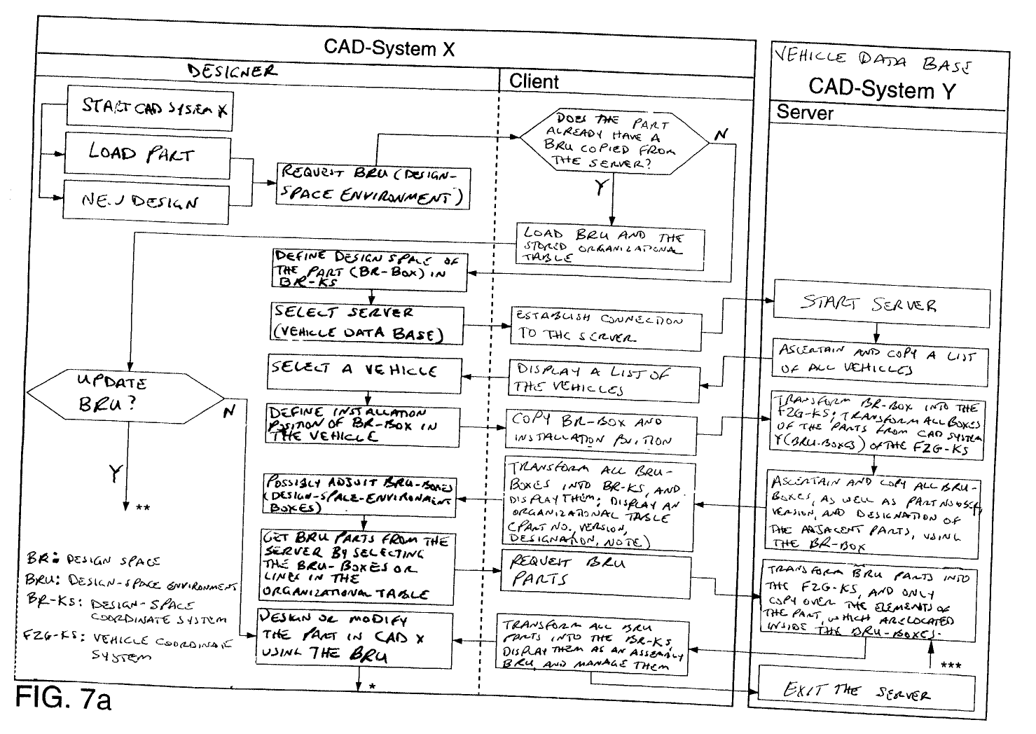

One example of an organizational table is illustrated in FIG. 6. All data concerning the parts of the design-space environment, which could be of interest to the designer, are stored. In addition to a number, the part number, the version, the designation, the type of representation, the status, and a note may be stored for each part of the design-space-environment, in the organizational table illustrated in FIG. 6. In this context, the representation type may be an exact geometric description TM or a simplified geometric description Lite of the specific part. The status of a part indicates whether the part is new or modified. It is entered as a note, whether the specific part in the selected design-space environment is represented completely or in detail form.

The design-space assembly whose file name is stored in design-space-environment file 8, as is the file name of the organizational table, includes the data about various parts 11 of the design-space environment, i.e., the parts listed in the organizational table, in the format required for processing by the CAD system to which the data-storage structure belongs.

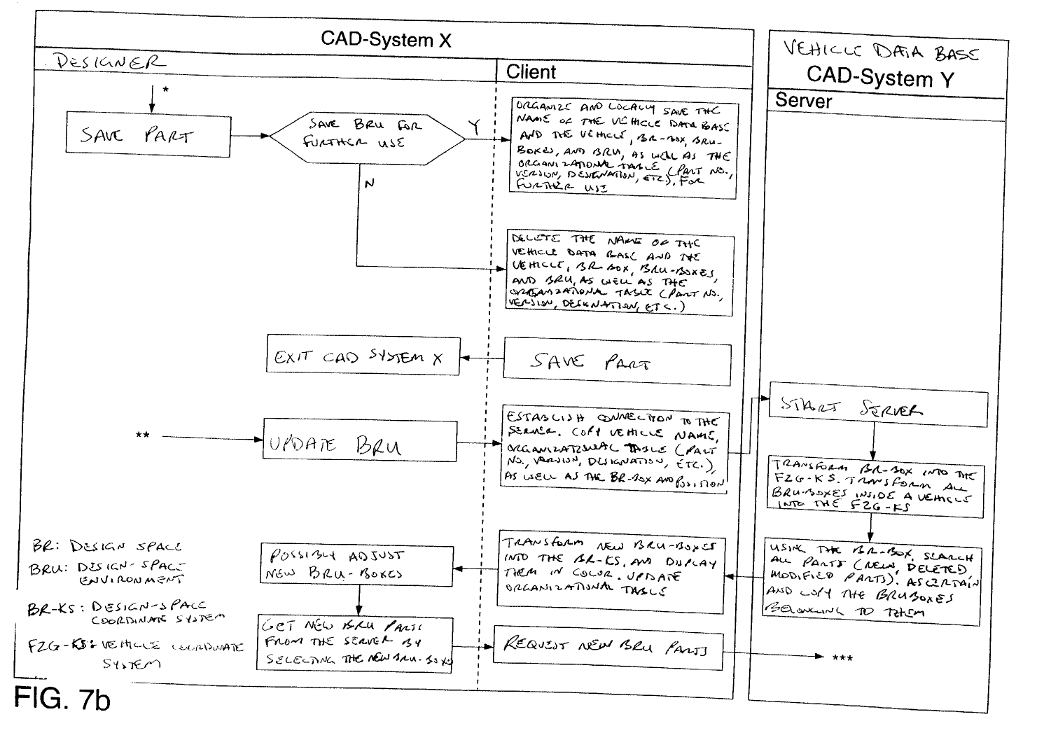

The method according to the present invention is described with reference to the flow chart illustrated in FIGS. 7a and 7b. The connection between blocks on different pages is indicated by asterisks (“*”, “**”, and “***”).

The left side of the flow chart in each of FIGS. 7a and 7b represents the operations in a CAD system X used by a designer to design a part. The operations on the server side are shown on the right side of each figure. Consequently, FIGS. 7a and 7b relate to the operations in vehicle data base F, which is connected to CAD system X via a data channel and relate to the communication between vehicle data base F, in which all relevant parts are intended to be stored, and an additional CAD system Y. The operations in CAD system X are further subdivided into a left region, in which the actions of the designer are illustrated, and a right region, in which the client-computer functions of CAD system X are shown.

The designer starts CAD system X and decides whether he wants to begin a new design or to continue with a part whose design has already been started, and he requests a design-space environment for the part. As a result, CAD system X determines whether a design-space environment already exists for the part. Initially, the method is only represented for the case in which there is no design-space environment stored for the new part to be designed.

The designer is asked to define a design-space BR-Box for the part, which establishes the region in design-space coordinate system BR-KS of CAD system X, where the part to be designed should be situated. In addition, the designer must select desired vehicle data base F as the server, in case that selection of more that one vehicle data base is possible. CAD system X then establishes a connection to the server of vehicle data base F, which is started, establishes a list of all available vehicles, and copies this list to CAD system X. CAD system X presents the designer with a list of vehicles, from which a vehicle is selected. In addition, the designer defines the installation position of design space BR-Box in this vehicle, whereupon both the dimensions of the design space and its installation position in the vehicle are communicated by CAD system X to vehicle data base F.

The design space of the part to be designed and the respective design spaces of all the previously stored parts for this vehicle are transformed in the vehicle data base, into vehicle coordinate system Fzg-KS. Consequently, the design spaces BRU-Box in vehicle data base F, which border on or overlap design space BRU-Box of the part to be designed, can now be selected as a design-space environment. The part number, version, and designation of the relevant parts are ascertained for these selected design-space-environment boxes BRU-Box and are copied to CAD system X, together with the design-space-environment boxes.

In CAD system X, all design-space-environment boxes BRU-Box are transformed into design-space coordinate system BR-KS and displayed as a simplified design-space environment similar to the one illustrated in FIG. 2. In addition, an organizational table is displayed, having the part number, version, and designation of parts belonging to the design-space-environment boxes, as well as a note corresponding to the table illustrated in FIG. 6.

If desired, the designer can select certain boxes from displayed design-space-environment boxes BRU-box and/or adjust them. The selection of desired design-space-environment boxes BRU-box is performed by selecting them in the display of the design-space environment or by preselecting the corresponding lines in the displayed organizational table.

The geometric representation of the parts of the trimmed design-space environment may now be requested via the client. All parts of the selected design-space-environment boxes are loaded from vehicle data base F into CAD system Y and transformed into vehicle coordinate system Fzg-KS. Only the elements of the specific parts located inside the trimmed design-space-environment boxes are copied to CAD system X.

The server may be exited as soon as all the trimmed parts of the design-space environment in CAD system X are transformed into design-space coordinate system BR-KS, represented as an assembly, and organized. Alternatively, the designer may now design the new part with the aid of the exact design-space environment similar to the one illustrated in FIG. 4. During the design or modification of a new part, the designer may unhide and hide the design-space environment as desired. Within the framework of subsequently storing the part (junction *), he must decide if the defined design-space environment should be saved for other applications, as well. If yes, then the name of the vehicle data base and the vehicle, design space BR-Box, the design-space environment having separate design-space-environment boxes BRU-Box belonging to it, as well as the organizational table, are organized and stored locally for other applications. Otherwise, the name of the vehicle data base and the vehicle type, design space BR-Box, the design-space environment, and the organizational table are deleted from CAD system X. In both cases, the data for the part itself is stored, and the designer can exit CAD system X.

If, upon starting CAD system X, a design-space environment already existed for the new part to be designed, then the design-space environment and the organizational table saved for it are loaded from CAD system X and displayed. Should the design-space environment be used again as displayed, without updating it, then the designer can immediately continue with the modification of the part, which is proceeded by the above-mentioned steps for storing the part Ounction *) In this case, it is not necessary to communicate with vehicle data base F.

However, if the designer wants to update the design-space environment (junction **), then CAD system X establishes a connection to corresponding vehicle data base F and copies the vehicle name, the contents of the organizational table, the data for design space BR-Box, and the position of the design space to the vehicle data base. As a result, the server is started and transforms design space BR-Box, and the design spaces for all parts already existing in CAD system Y, into vehicle coordinate system Fzg-KS, as design-space-environment boxes BRU-Box. Using design space BR-Box, all existing parts are searched for new, deleted, or modified parts, and the corresponding design-space-environment boxes are ascertained and copied to CAD system X.

CAD system X transforms the new design-space-environment boxes into design-space coordinate system BR-KS and displays them in a different color. In addition, CAD system X updates the organizational table. Now, the designer can once again adjust the new design-space environment, and, by selecting the new design-space-environment boxes, he can request the new parts in vehicle data base F via CAD system X (junction ***). In vehicle data base F, the parts are subsequently transformed into vehicle coordinate system Fzg-KS, and the elements of the parts, which are obtained from CAD system Y and are located inside the adjusted design-space-environment boxes, are copied to CAD system X, as described above with regard to creating a new design-space environment. From this point on, the further steps also correspond to the method, in the case of a newly created design-space environment.

The parts may be transformed into vehicle coordinate system Fzg-KS using transformation matrices. The transformation matrices contain information about a translation in the x, y, and z directions as well as a rotation about the x, y, and z axes. The transformation matrices may be saved in vehicle data base F for each of the previously designed parts.

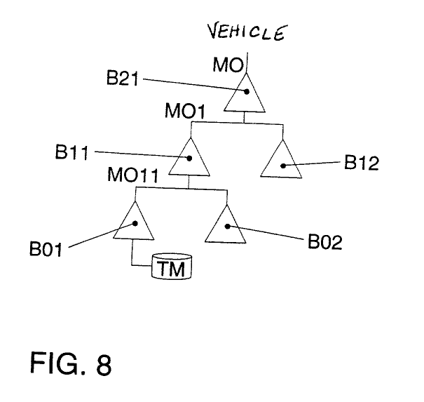

A part is either a component part or an assembly, which includes a plurality of parts, each part having a separate design-space BR-Box, BRU-Box. The assignment of a part to an assembly is performed by transformation matrices, and it follows the pattern illustrated in FIG. 8, in which part B01 belongs to assembly B11, which in turn, forms a part of assembly B21.

Part B01 illustrated in FIG. 8, whose design space BR-Box is defined in design-space coordinate system BR-KS, shall be newly designed with its precise geometric data TM in CAD system X. The installation position of part B01 is defined in assembly B11, by transformation matrix M011. For its part, the installation position of assembly B11 in superordinate assembly B21 is defined by transformation matrix M01. The final installation position of assembly B21 in the vehicle is described by transformation matrix M0.

In vehicle data base F, the geometric data for the previously created component parts are stored in the respective, system-inherent format, and in the design-space coordinate system BR-KS in which they were created, both as an exact representation and a simplified representation TM and Lite. Analogously to the representation illustrated in FIG. 8, the respective position of the individual parts in the superordinate assemblies and the respective position of the most comprehensive assemblies in the vehicle are defined by transformation matrices.

To ascertain the design-space environment for part B01 to be designed new, design spaces BRU-Box, which belong to the already created parts and overlap or border on design space BR-Box of part B01 to be designed, are determined.

For this purpose, design space BR-Box of part B01 is initially transformed by transformation matrices M011, M01, and M0 from design-space coordinate system BR-KS into vehicle coordinate system Fzg-KS and is subsequently transferred into vehicle data base F. Then, the individual design spaces of the existing parts must also be transformed by the corresponding transformation matrices from respective design-space coordinate system BR-KS into vehicle coordinate system Fzg-KS.

As a result, both design space BR-Box of the part to be designed new and the design spaces of the existing parts are then available in the vehicle data base, in vehicle coordinate system Fzg-KS, so that the design-space environment for the part to be designed new can be easily ascertained.

What is claimed is:

1. A design system for designing new parts of a design unit in a design-space environment including preexisting parts of the design unit, comprising:
at least one CAx system; and
at least one central data base connected to the at least one CAx system via a data circuit configured to exchange data;
wherein a first CAx system includes:
an input device configured to define a design space for a part to be designed and to design the part to be designed in the design space;
a display device configured to display the design space, a design-space environment and parts;
a copying device configured to copy the design space to the central data base;
and wherein the central data base is configured to access the preexisting parts of at least one design unit and includes:
a selection device configured to select the preexisting parts of the design unit that at least one of overlap and border on the design space of the part to be designed and to select the preexisting parts, the design spaces of which at least one of overlap and border on the design space of the part to be designed; and
a copying device configured to copy to the CAx system as a design-space environment the selected parts with data representing a position of the selected parts relative to the design space.

2. The design system according to claim 1, wherein the central data base includes a storage device configured to store data representing a finished part, data representing the design space of the finished part and data representing an installation position of the finished part, the finished part being designed in accordance with the CAx system.

3. The design system according to claim 1, wherein the CAx system includes a storage device configured to store data representing a design-space environment corresponding to the part to be designed.

4. The design system according to claim 1, wherein the CAx system includes a storage device configured to store an organizational data relating to the parts of the design-space environment, the organizational data being selectively available to a user and including, for each part of the design-space environment, data representing at least one of a number, a part number, a version number, a designation, a status and a note.

5. The design system according to claim 4, wherein the status includes at least one of a new status and a modified status.

6. The design system according to claim 1, wherein the CAx system includes a data-storage structure configured to store design-space-environment data assigned to a part, a design-space-environment flag indicating whether a design-space environment is stored for the part and a name of a design-space-environment storage file assigned to a file that includes the data for the part to be designed;
wherein the design-space-environment storage file includes a name of a file that includes an organizational table containing the organizational data for the parts of the design-space environment, the definition of the design space for the part to be designed, a list of the design spaces for the parts of the design-space environment and a name of a file of a design-space-environment assembly; and
wherein the design-space-environment assembly includes data representing the parts of the design-space environment in a format used by the CAx system.

7. The design system according to claim 1, wherein the design system includes a plurality of CAx systems, each of the CAx systems being connected to the at least one central data base via the data circuit.

8. The design system according to claim 1, wherein the design system includes a plurality of central data bases, each of the central data bases being connected to the at least one CAx system via the data circuit, a first central data base being selectable via the CAx system used for the part to be designed.

9. The design system according to claim 1, further comprising an adapter connecting the data circuit and the at least one CAx system and an application programming interface connecting the data circuit and the at least one central data base, wherein the adapter, the application programming interface and data circuit are configured to transmit data between the at least one CAx system and the at least one central data base.

10. The design system according to claim 1, wherein the design unit includes a motor vehicle.

11. A method for designing new parts of a design unit in a design-space environment that includes preexisting parts of the design unit and with a design system that includes at least one CAx system and at least one central data base, the at least one CAx system and the at least one central data base being interconnected via a data circuit, comprising the steps of:
(a) copying to the central data base a design space defined in the CAx system by a user and relating to a part to be designed;
(b) determining, in accordance with the central data base, preexisting parts of the design unit that at least one of border on and overlap the design space of the part to be designed and preexisting parts having design spaces that at least one of border on and overlap the design space of the part to be designed;
(c) copying to the CAx system the determined preexisting parts and data representing a position of the determined preexisting parts relative to the design space of the part to be design; and
(d) displaying the determined preexisting parts in a correct position relative to the design space of the part to be designed as a design-space environment for designing the part to be designed.

12. The method according to claim 11, wherein the determining step (b) includes the substeps of:
initially determining in the central data base the design spaces of the preexisting parts that at least one of border on and overlap the design space of the part to be designed;
copying the initially determined design spaces to the CAx system;
copying to the central data base preexisting design spaces that have been selected in the CAx system by a user and preexisting design spaces that have been adjusted in size; and
copying one of in detail form and completely from the central data base to the CAx system preexisting parts contained within selected design spaces and in accordance with the size adjustment.

13. The method according to claim 11, further comprising the step of making the design-space environment visible and invisible in accordance with an input of the user while the user is designing the part to be designed.

14. The method according to claim 11, further comprising the step of storing data representing the design-space environment corresponding to the part to be designed with data representing the part to be designed.

15. The method according to claim 11, further comprising the step of updating the design-space environment while designing the part to be designed.

16. The method according to claim 15, further comprising the step of copying and updating only modified parts from the central data base to the CAx system in accordance with the design-space environment updating step.

17. The method according to claim 11, wherein the design unit includes a motor vehicle, the central data base being configured to access the parts to a plurality of motor vehicles and wherein the method further comprises the step of requesting the design-space environment for a specific vehicle for the part to be designed.

18. The method according to claim 11, further comprising the steps of:
representing the design space and the design-space environment in the CAx system in a design-space coordinate system;
determining at least one of the parts and the design spaces of the parts in the central data base in a design-unit coordinate system;
copying design spaces from the CAx system to the central data base to determine preexisting parts being transformed from the design-space coordinate system to the design-unit coordinate system; and
transforming the copied design spaces and preexisting parts from the design-unit coordinate system to the design-space coordinate system.

19. The method according to claim 11, further comprising the step of converting by the CAx system for the part to be designed data representing the design-space environment into a format usable by the CAx system if the data representing the preexisting parts of the design space environment is received in a different format.

20. The method according to claim 11, further comprising the step of temporarily storing in the CAx system data for managing the parts of the design-space environment, the data for managing the parts of the design-space environment being accessible by the user.

21. The method according to claim 20, wherein the data for managing the parts of the design-space environment includes data representing at least one of a part number, a version number and a designation.

22. The method according to claim 11, wherein the at least one central data base includes a plurality of central data bases, the method further comprising the step of determining the design-space environment in accordance with a selected one of the central data bases.

23. The method according to claim 11, further comprising the step of copying a finished part to the central data base, the finished part selectively representing a component of a subsequently defined design-space environment.
